(19) United States
(12) Patent Application Publication
(10) Pub. No.: US 2019/0047381 A1
(43) Pub. Date: Feb. 14, 2019

(54) SHADING SYSTEM FOR A VEHICLE PASSENGER COMPARTMENT

(71) Applicant: BOS GMBH & CO. KG, Ostfildern (DE)

(72) Inventors: Jan LEKAR, Ostfildern (DE); Michele TINA, Ostfildern (DE)

(21) Appl. No.: 16/076,843

(22) PCT Filed: Jan. 17, 2017
(86) PCT No.: PCT/EP2017/050888

§ 371 Date: Aug. 9, 2018

(30) Foreign Application Priority Data
Feb. 10, 2016 (DE) 10 2016 202 016.1

(51) Int. Cl. B60J 1/20

(52) U.S. Cl. CPC B60J 1/2063; B60J 1/2041; B60J 1/2016

(57) ABSTRACT

Shading system having at least one flexible planar structure mounted such that it can be wound onto at least one winding shaft between a wound-on position of rest and at least one at least partially extended functional position and unwound therefrom. A plurality of strip sections extend in parallel with respect to one another and have different translucency values. A control device changes the translucency of the planar structure through spatial displacement of the planar structure. Two flexible planar structures are provided and are displaceable in parallel or transversely. Each planar structure is provided with strip sections which run longitudinally or transversely and have different translucency values. The control device acts mechanically on at least one planar structure and has at least one manually-operated actuator element.

The invention relates to a shading system for a vehicle passenger compartment having at least one flexible planar structure which is mounted in such a way that it can be wound onto at least one winding shaft between a wound-on position of rest and at least one at least partially extended functional position and unwound therefrom, and which has a plurality of strip sections which are extended in parallel with respect to one another and which have different translucency values, as well as having a control device which changes the translucency of the planar structure through spatial displacement of the planar structure.

DE 103 23 605 B4 discloses a protection device for a cargo space of a motor vehicle, which protection device has a planar structure which can be alternatively moved into an approximately vertical protection position or into an approximately horizontal protection position. In the approximately horizontal protection position, the planar structure serves as a visual protection or privacy protection for cargo which is located underneath the approximately horizontally extended cargo space cover. In the approximately vertically extended protection position, the translucency of the planar structure is increased, which permits a driver of the motor vehicle to look rearward through the rearview mirror. The flexible planar structure has transversely running strip sections and is doubled in the manner of a web which runs all around. In this context, the planar structure is deflected about a deflection roller which, when displacement occurs from the horizontal protection position into the vertical protection position of the planar structure, brings about forced displacement of the strip sections of the doubled web sections of the planar structure.

The object of the invention is to provide a shading system of the type mentioned at the beginning which permits the translucency of the shading system to be changed using simple means.

This object is achieved by virtue of the fact that two flexible planar structures which can be displaced in parallel or transversely with respect to one another are provided, which planar structures are each provided with strip sections which run longitudinally or transversely and have different translucency values, and that the control device acts mechanically on at least one planar structure and has at least one actuator element which can be operated manually. By means of the solution according to the invention it is possible to bring about a change in the translucency of the at least one planar structure through simple manual operation of the actuator element. As a result, different shading values for a vehicle passenger compartment can be obtained. The solution according to the invention is particularly advantageously suitable for use in a passenger car, preferably in the region of a side door of the passenger car. However, it is also possible to use the solution according to the invention in the passenger compartment of other vehicles for use in the air, on land and in the water. The control device is advantageously embodied mechanically and accordingly independent of an application of current. The essential concept of the invention is that in the respectively extended functional position the two planar structures which are independent of one another complement one another in terms of their respective strip sections in such a way that increased or reduced translucency is achieved depending on the position of the strip sections of the various planar structures. Depending on whether the two planar structures can be displaced in parallel or transversely with respect to one another, the strip sections are also configured in such a way that in the extended functional position a parallel orientation of all the strip sections is always produced. In the case of planar structures which are oriented transversely with respect to one another, the strip sections of the one planar structure are accordingly oriented longitudinally or transversely, while the strip sections of the other planar structure are correspondingly conversely oriented transversely or longitudinally, with matching to the orientation of the strip sections of the first planar structure.

In one refinement of the invention, each planar structure is mounted in such a way that it can be wound onto, in each case, one winding shaft and unwound therefrom, wherein the winding shafts are oriented in parallel or at an angle with respect to one another. If the two planar structures are pulled out or retracted transversely with respect to one another, the winding shafts of the planar structures are also oriented at an angle with respect to one another in a correspondingly adapted fashion. An angular orientation means, in particular, an orthogonal, i.e. right-angled, orientation, but also orientations which differ from a right angle by a few degrees.

The solution according to the invention is particularly advantageously suitable for shading side windows of a motor vehicle, wherein simple manual operation of the actuator element of the shading system by a corresponding vehicle occupant is easily provided from the vehicle passenger compartment.

The object on which the invention is based is also achieved by virtue of the fact that an individual flexible planar structure is provided which is deflected to form two partial planar regions which are positioned one on top of the other and are at least largely parallel with respect to one another. As a result, the translucency of the shading system is also changed in the extended functional position of the planar structure using simple means.

In one refinement of the invention the two partial planar regions are secured on a common winding shaft that they can be wound thereon and unwound therefrom. Corresponding winding-shaft-side end regions of the partial planar regions are secured on the common winding shaft in such a way that they can be pulled off the winding shaft in opposite directions from one another. The partial planar regions can be formed by a single planar web which is manufactured continuously or by two planar webs which are manufactured separately from one another and connected to one another at the ends.

In a further refinement of the invention, in each case one winding shaft is provided for each of the two partial planar regions, in order to wind on or unwind the respective partial planar region. This refinement is an alternative to the embodiment with the common winding shaft.

In a further refinement of the invention, at least one partial planar region is deflected by means of a clamping strip which exerts a tensile load on the partial planar region in the longitudinal direction of the planar structure. The clamping strip is elastically prestressed, in particular by means of a spring unit, and is oriented in parallel with the at least one winding shaft.

In a further refinement of the invention, each planar structure or each partial planar region has a dimensionally stable pull-out profile at its end region which is at the front in the unwinding direction. The dimensionally stable pull-out profile is permanently connected to the respective planar structure at its end region over the entire width of the planar structure. The respective pull-out profile is preferably guided in such a way that it can be displaced in parallel in at least one lateral guidance means, which is fixed to the vehicle, in the region of at least one of its ends lying opposite one another.

In a further refinement of the invention, at least one pull-out profile and/or at least one winding shaft is/are mounted so as to be movable in the longitudinal direction or transverse direction of the planar structure or of the partial planar region, and the control device has at least one mechanical control means which, when activation by the manually operated actuator element occurs, exerts forced guidance on at least one pull-out profile and/or at least one winding shaft in the longitudinal direction or transverse direction. Corresponding relative displacement of the respective pull-out profile and/or of the respective winding shaft results in the desired relative displacement of the two planar structures with respect to one another, as a result of which the change in the translucency can be brought about.

In a further refinement of the invention, the mechanical control means has a mechanical operative connection to the manually operated actuator element. The mechanical control means has, in particular, a pivoting joint, a crank joint or an elongated pulling line/pushing line in particular in the manner of a Bowden cable. The manually operated actuator element is preferably embodied as a slide, as a rotationally movable actuator wheel or as a pivotable actuator lever.

In a further refinement of the invention, the two pull-out profiles of the planar structures or partial planar regions are adjustably secured in a common carrier profile, wherein the mechanical control means is assigned to the carrier profile. The carrier profile can be displaced together with the two pull-out profiles between a position of rest and an extended functional position of the at least one planar structure and can be secured on the vehicle passenger compartment side in the extended functional position. The carrier profile also serves to accommodate and support the two pull-out profiles in order to guide and ensure the desired relative mobility of the two pull-out profiles relative to one another.

In a further refinement of the invention, the manually operated actuator element is mounted on the carrier profile. Alternatively, the actuator element is mounted on the vehicle passenger compartment side. In both cases, the manually operated actuator element is easily accessible to a corresponding vehicle occupant from the vehicle passenger compartment, in order to be able to operate said actuator element. Vehicle-passenger-compartment-side mounting is understood to mean mounting in the region of a movable side door or of a fixed vehicle passenger compartment boundary.

Further advantages and features of the invention are found in the claims as well as in the following description of preferred exemplary embodiments of the invention which are illustrated on the basis of the drawings.

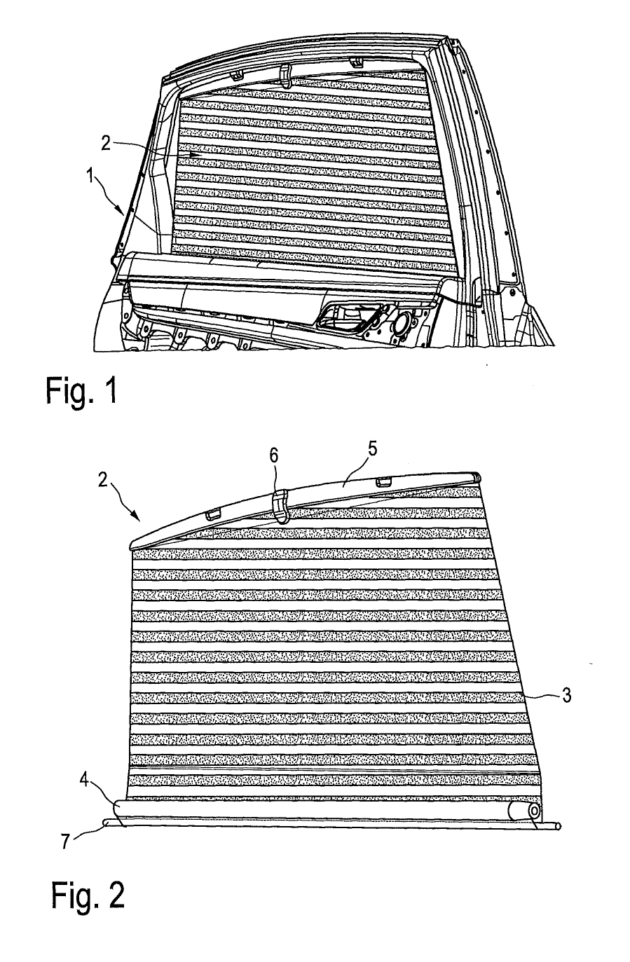

FIG. 1 shows a perspective illustration of a detail of a vehicle door of a passenger car with an embodiment of a shading system according to the invention,

FIG. 2 shows the shading system according to FIG. 1 in a first functional position,

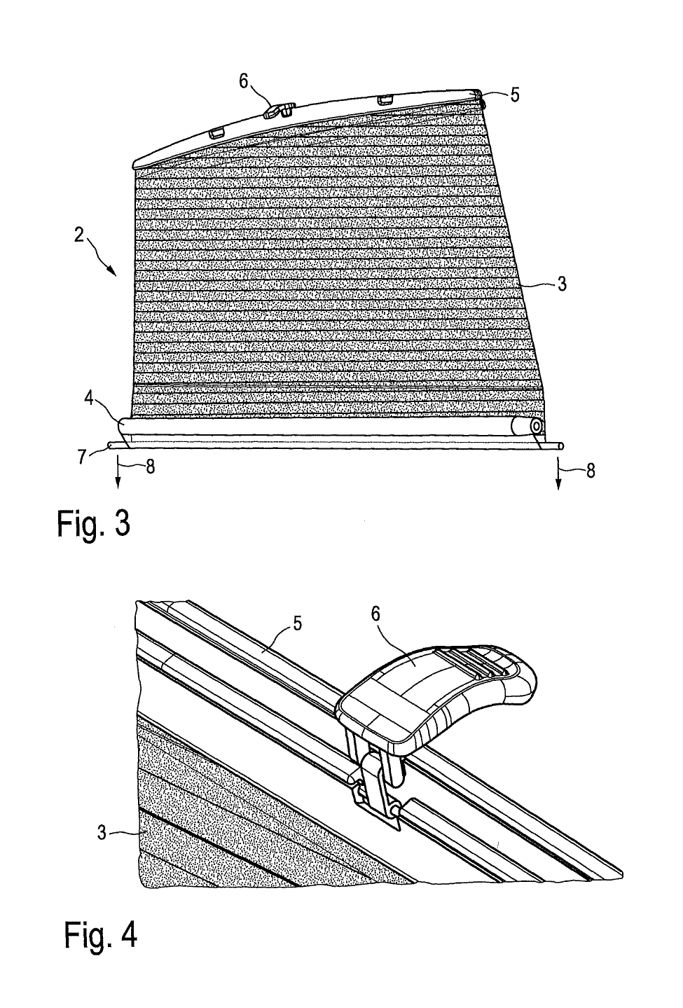

FIG. 3 shows the shading system according to FIG. 2 in a second functional position with reduced translucency,

FIG. 4 shows an enlarged perspective illustration of a detail of the shading system according to FIG. 3,

FIG. 5 shows an enlarged, perspective illustration of a detail of the shading system in the functional position according to FIG. 2,

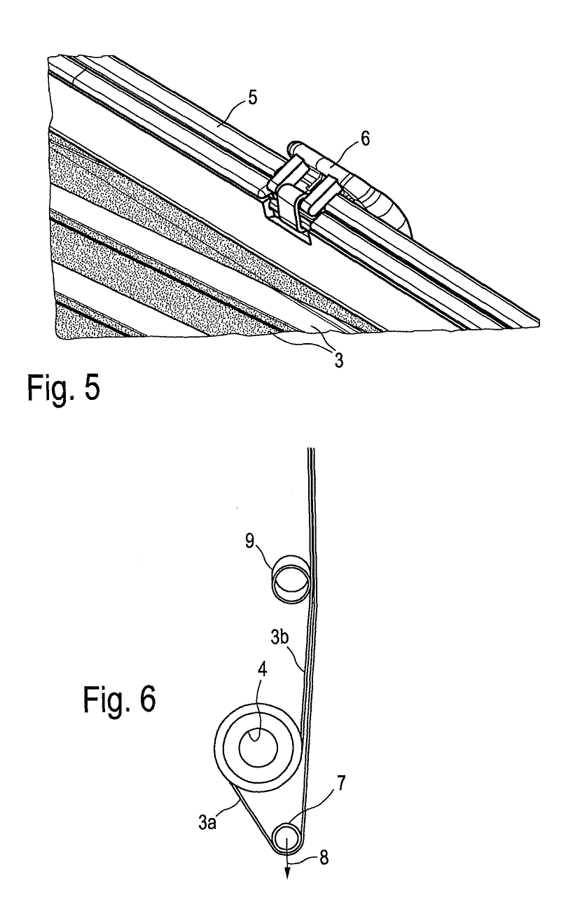

FIG. 6 shows the shading system according to FIGS. 1 to 5 in a schematic cross-sectional illustration,

FIG. 7 shows a schematic illustration of an embodiment of a shading system according to the invention with the same principle as the embodiment according to FIGS. 1 to 6,

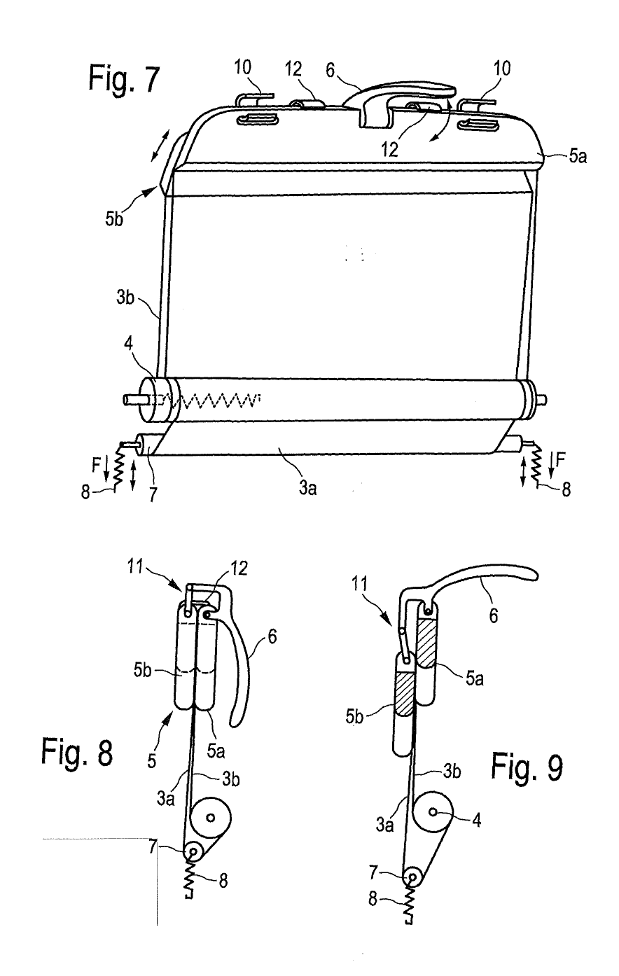

FIG. 8 shows the shading system according to FIG. 7 in a schematic cross-sectional illustration in a first functional position,

FIG. 9 shows the shading system according to FIG. 8 in a second functional position,

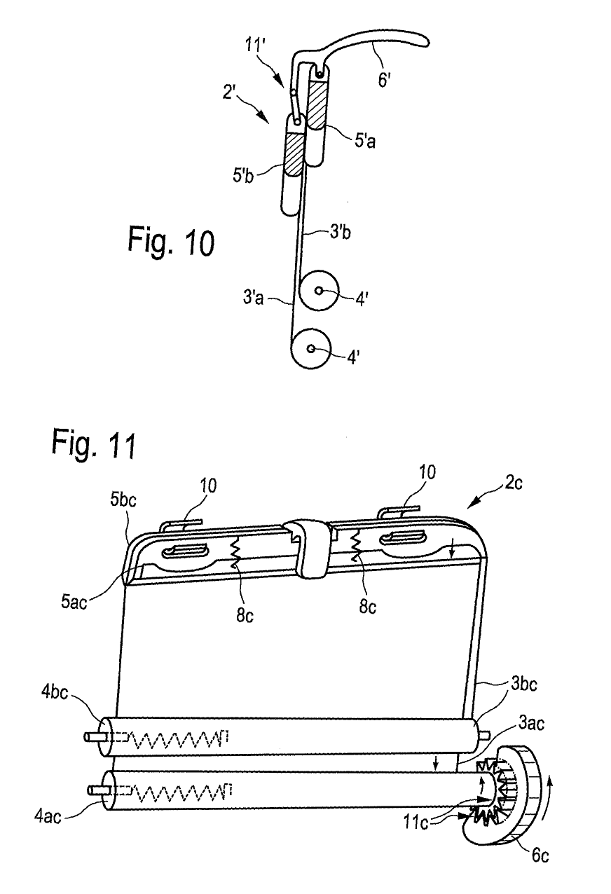

FIG. 10 shows a schematic cross-sectional illustration of a further embodiment of a shading system according to the invention, similar to FIGS. 7 to 9,

FIG. 11 shows a schematic illustration of a further embodiment of a shading system according to the invention,

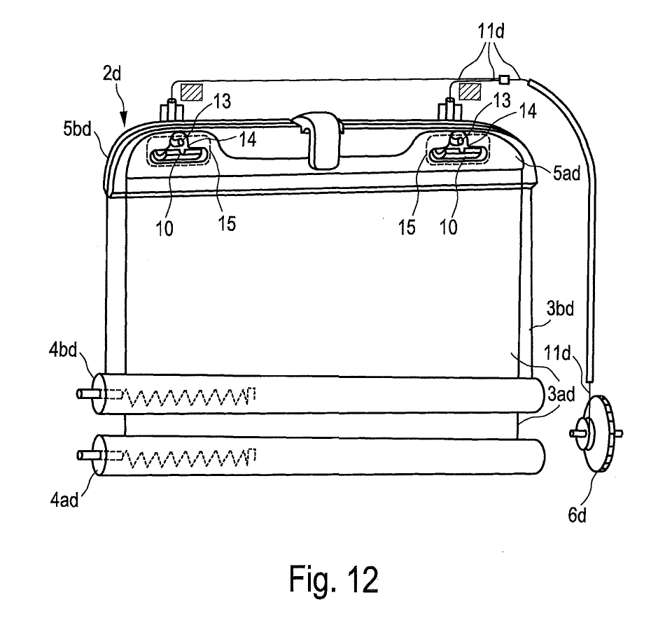

FIG. 12 shows a schematic illustration of a further embodiment of a shading system according to the invention,

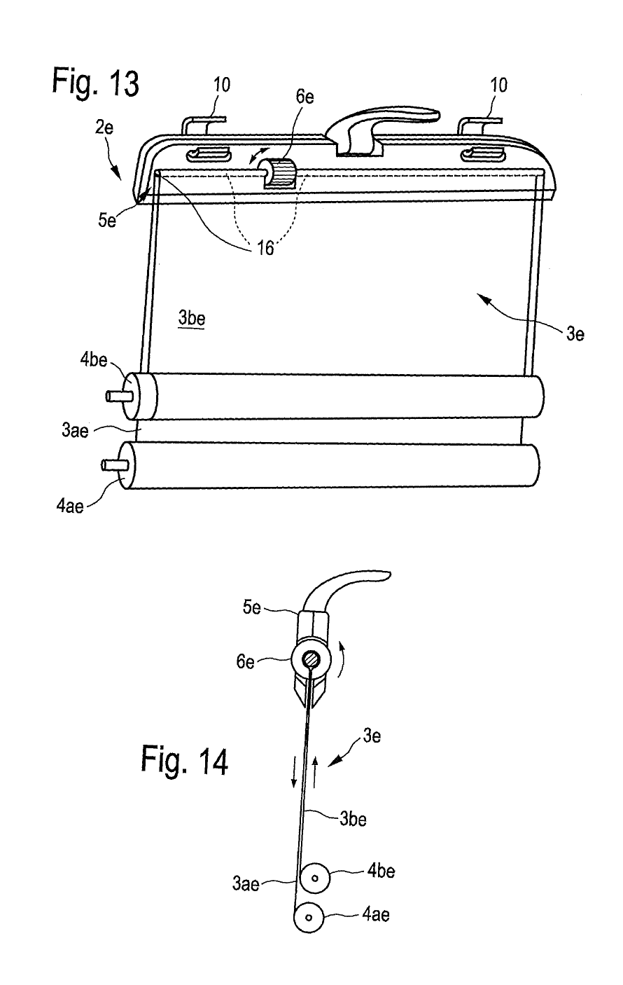

FIG. 13 shows a schematic illustration of a further embodiment of a shading system according to the invention,

FIG. 14 shows a schematic cross-sectional illustration of the shading system according to FIG. 13,

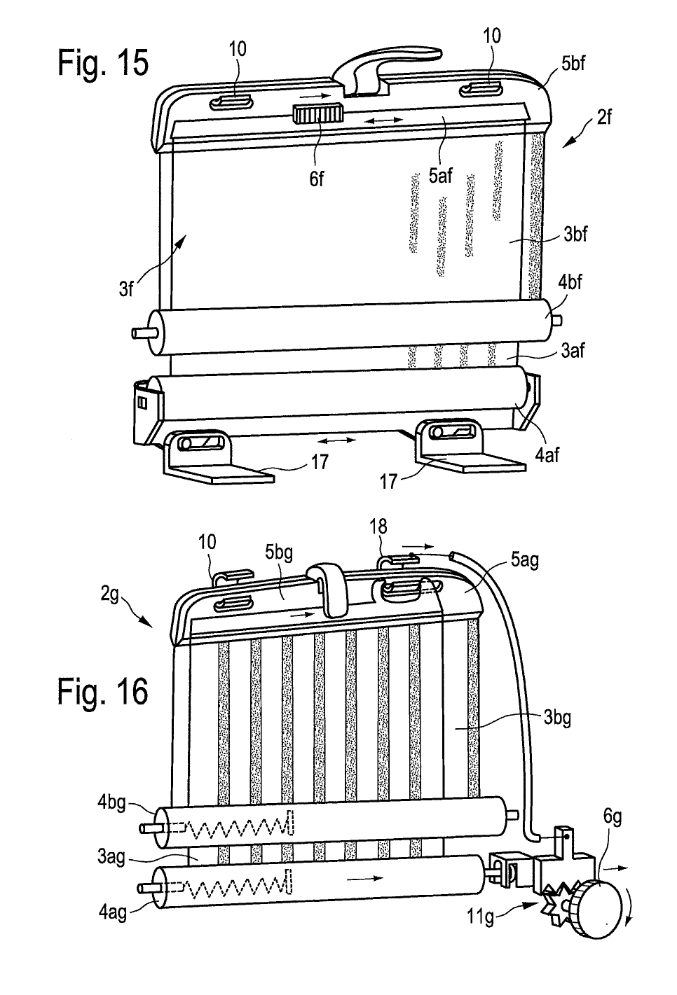

FIG. 15 shows a further embodiment of a shading system according to the invention,

FIG. 16 shows a schematic illustration of a further embodiment of a shading system according to the invention,

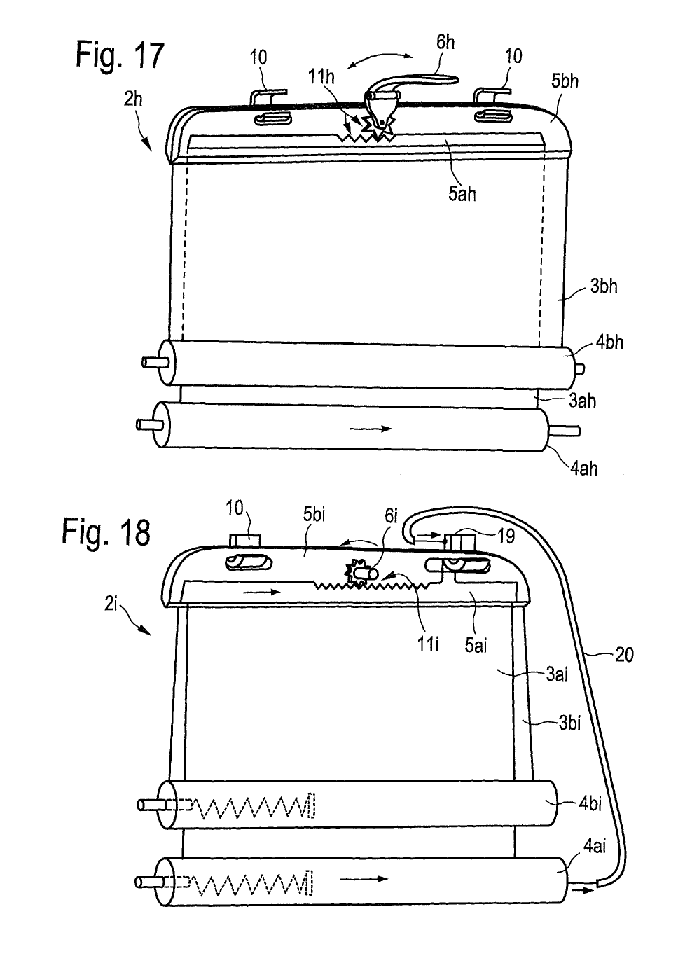

FIG. 17 shows a schematic illustration of a further embodiment of a shading system according to the invention,

FIG. 18 shows a schematic illustration of a further embodiment of a shading system according to the invention,

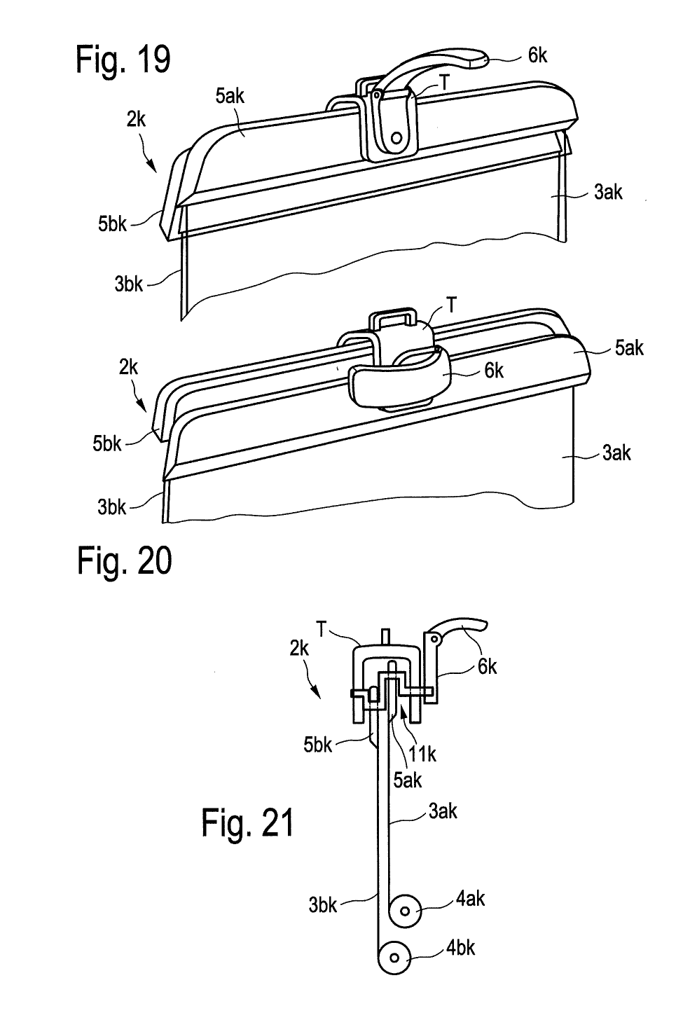

FIGS. 19 and 20 show a partial region of a further embodiment of a shading system according to the invention,

FIG. 21 shows a schematic cross-sectional illustration of the shading system according to FIGS. 19 and 20,

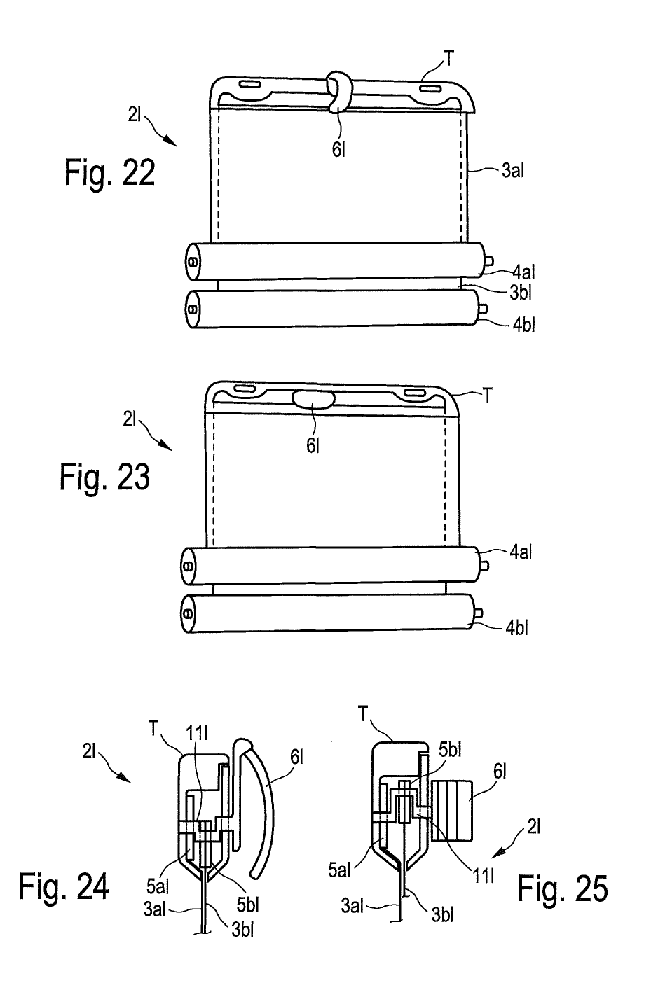

FIGS. 22 and 23 show a further embodiment of a shading system according to the invention, similar to FIGS. 19 to 21,

FIGS. 24 and 25 show a schematic cross-sectional illustration of an upper partial region of the shading system according to FIGS. 22 and 23 in two different functional positions,

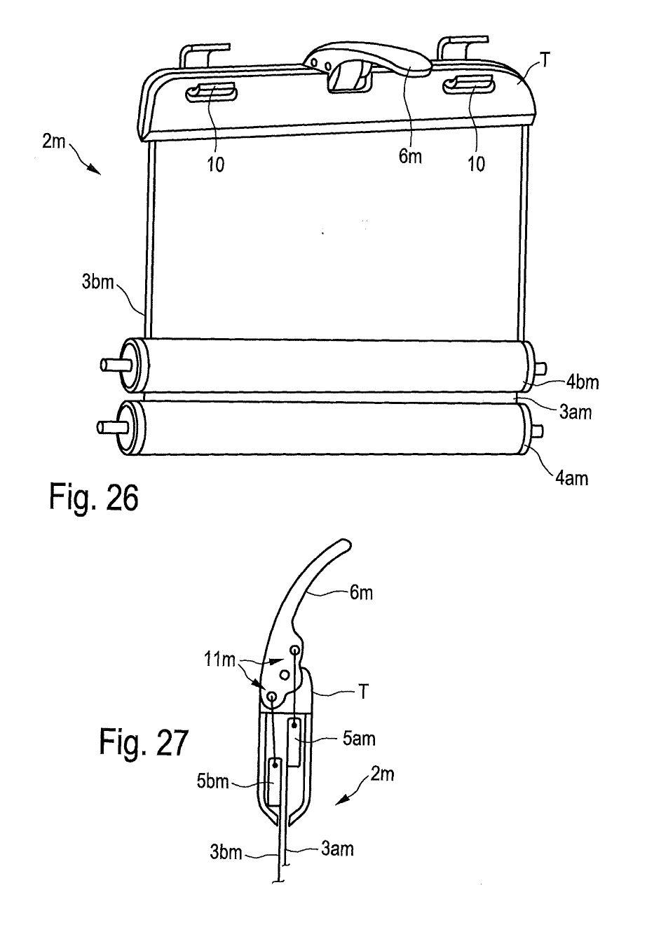

FIG. 26 shows a further embodiment of a shading system according to the invention,

FIG. 27 shows a schematic cross-sectional illustration of an upper partial region of the shading system according to FIG. 26,

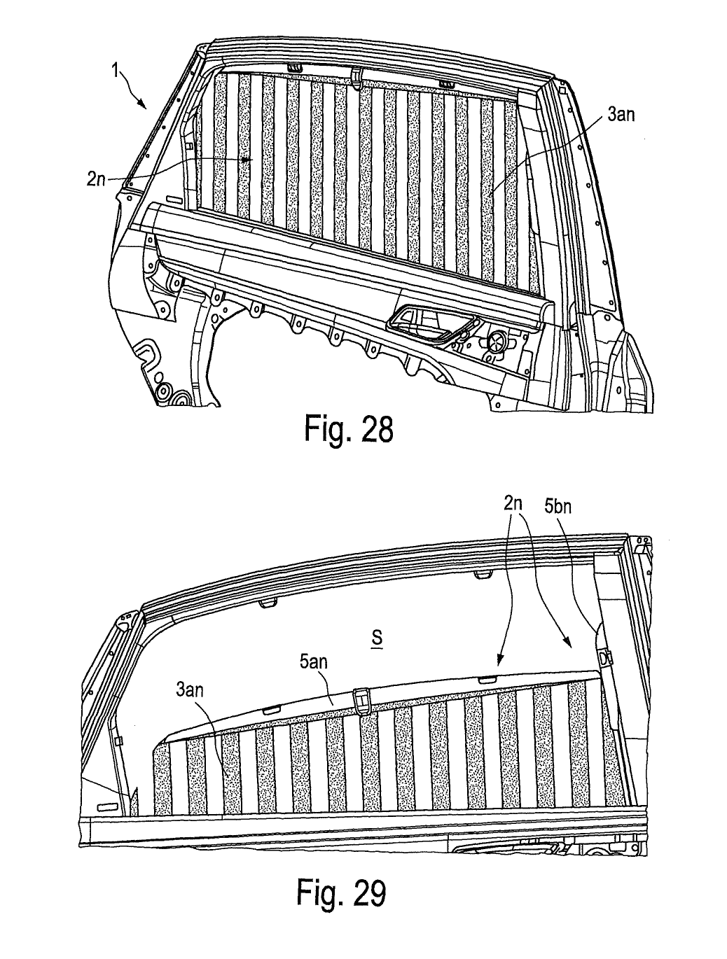

FIG. 28 shows a partial region of a side door of a passenger car with a further embodiment of a shading system according to the invention,

FIG. 29 shows another perspective of the side door according to FIG. 28 with a flexible planar structure, displaced into a partially extended functional position, of the shading system according to FIG. 28,

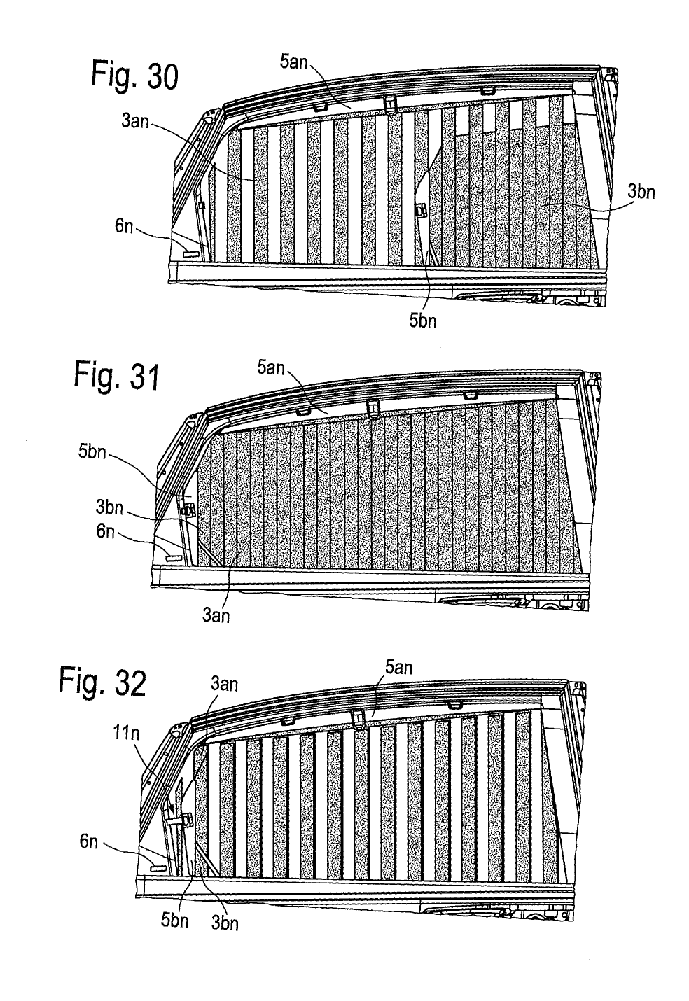

FIGS. 30 to 32 show the shading system according to FIGS. 28 and 29 in different functional positions of a further planar structure which can be displaced transversely with respect to the first planar structure, and

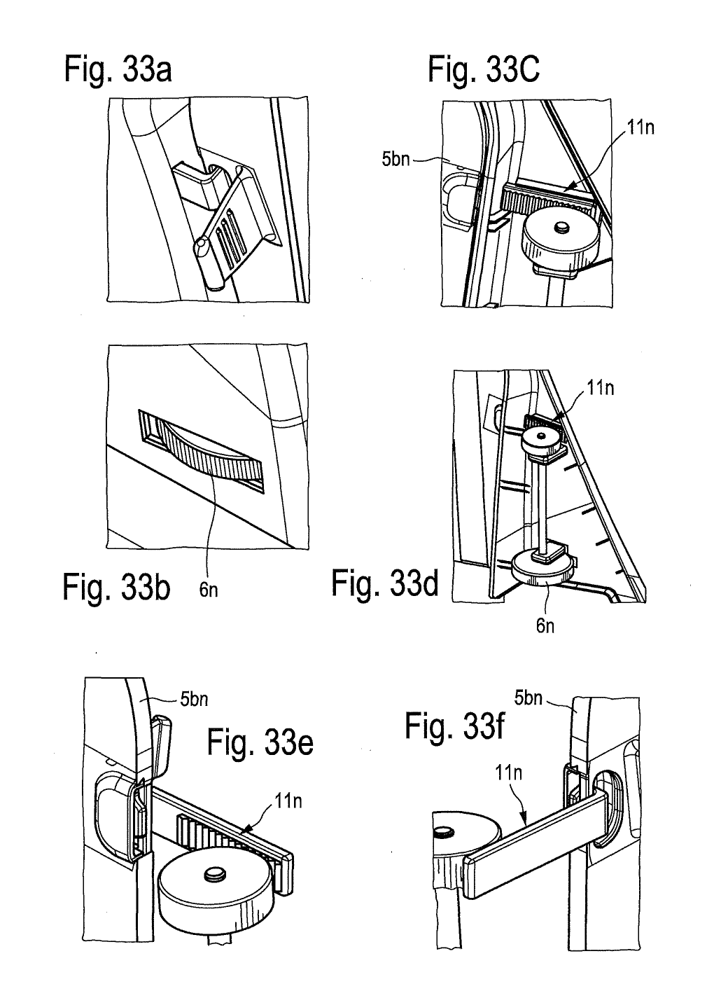

FIGS. 33a to 33f show schematic views of various details of the shading system according to FIGS. 28 to 32, and

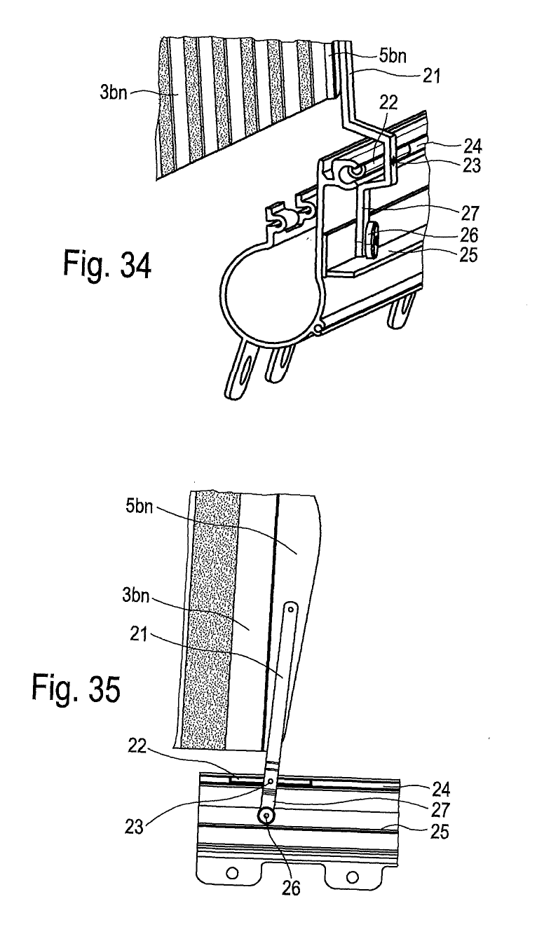

FIGS. 34 to 37 show details of a guiding means of the further planar structure according to FIGS. 30 to 32.

A passenger car has, in a basically known fashion, four side doors, two side doors of which are assigned to front vehicle seats and two side doors of which are assigned to rear vehicle seats. A side door 1 according to FIG. 1 is a rear side door of the passenger car. The side door 1 has, above a sill which is not noted in more detail, a side window arrangement which can be shaded by a shading system 2. The shading system 2 is provided in the region of an inner side of the side door 1 and accordingly is accessible and can be operated from a vehicle passenger compartment of the passenger car.

The shading system 2 has, according to FIGS. 1 to 9, two flexible planar structures 3a, 3b which together form a shading structure 3. The two flexible planar structures 3a, 3b are each manufactured in a web shape from a flexible planar structure or a plastic film. The two planar structures 3a and 3b are secured to a common winding shaft 4 in such a way that they can be wound on and unwound, to which winding shaft 4 torque is continuously applied by means of a winding spring (not denoted in more detail) in the winding on direction of the planar structures 3a and 3b. The winding shaft 4 is mounted in a rotationally movable fashion underneath the sill of the side door 1, and fixedly with respect to the door. As can be seen from FIGS. 7 to 9, the two planar structures 3a and 3b are moved away on opposite sides of the winding shaft 4, wherein the one planar structure 3a is deflected about a clamping shaft 7 which is oriented in parallel to the winding shaft 4 and is continuously spring-loaded in the extension direction of the planar structure 3a by means of a clamping device 8. Each planar structure 3a, 3b is permanently connected by its end region, which is at the front in the unwinding direction, to a dimensionally stable pull-out profile 5a, 5b. The two pull-out profiles 5a and 5b are guided bearing one against the other in parallel with respect to one another by means of a guide profile 9 and a guide clamp 12. The two planar structures 3a, 3b are provided with strip sections which run transversely with respect to the longitudinal direction of the respective planar structure 3a, 3b and which are provided in parallel with respect to one another and with the same width. The strip sections are alternately provided with different translucency values in that in each case a dark strip with low translucency is followed in the longitudinal direction of the respective planar structure 3a, 3b by a light strip section with high translucency.

As is apparent from FIGS. 2 and 3, it is possible to control the shading structure 3 overall with different translucency in that the two planar structures 3a, 3b are easily slightly shifted in the longitudinal direction relative to one another. The two planar structures 3a and 3b run essentially parallel with respect to one another in the upward direction as far as the corresponding pull-out profile 5a, 5b, which profiles are positioned in parallel one behind the other. As a result of corresponding relative shifting of both planar structures 3a, 3b in the longitudinal direction with respect to one another either two equally translucent strip sections, or two unequally translucent strip sections, lie above one another orthogonally with respect to the side window arrangement. This results either in relatively high translucency according to FIG. 2 or in translucency which is reduced to a maximum extent according to FIG. 3. This can be varied in an essentially stepless fashion through, in each case, overlapping of the strip sections only in certain sections, i.e. partial overlapping. The control of the planar structures 3a and 3b in the longitudinal direction relative to one another takes place in a simple way by displacement of the pull-out profiles 5a and 5b in the longitudinal direction of the planar structures 3a and 3b relative to one another, as can be seen from FIGS. 7 to 9. For this purpose, a mechanical control device 11 is provided which acts on the two pull-out profiles 5a and 5b in the manner of a slider element. The mechanical control device comprises a manually operated actuator element 6 which is configured as a simple pivoting lever. The manually operated actuator element 6 can be positioned in two positions and secured in a frictionally or positively locking fashion, specifically either in the position according to FIGS. 2, 5 and 8 or in the position according to FIGS. 3, 4 and 9.

On the basis of FIG. 7 it is apparent that in a pulled-out functional position of the shading structure 3 the one pull-out profile 5a is secured to upper suspension means which are fixed to the door, while the other pull-out profile 5b can be displaced relative to the secured pull-out profile 5a by means of the actuator element 6 and of the mechanical control device 11. The corresponding securing clamps 12 serve to secure the pull-out profile 5b to the pull-out profile 5a in the first position according to FIGS. 2, 5 and 8.

A shading system 2′ according to FIG. 10 corresponds essentially to the shading system 2 according to FIGS. 1 to 9. Functionally identical parts and sections are provided with the same reference symbols with the addition of a prime symbol'. An essential difference with the shading system 2′ according to FIG. 10 is that the two planar structures 3′a, 3′b are not secured to a common winding shaft but instead on two winding shafts 4′ which are mounted in parallel one on top of the other and fixedly with respect to the door. The guidance of the two pull-out profiles 5′a and 5′b as well as the relative control of the pull-out profiles 5′a, 5′b relative to one another by means of the mechanical control device 11′ and the manually operated actuator element 6′ corresponds to the embodiment described above, with the result that in order to avoid repetitions reference is made to the embodiments according to FIGS. 1 to 9.

The shading system 2c according to FIG. 11 is also similar, in terms of its basic function, to the two shading systems 2 and 2′ described above. The two planar structures 3ac and 3bc are also provided there with strip sections (not illustrated) running transversely with respect to their longitudinal direction, in a way analogous to the embodiments described above. In the case of the shading system 2c, the translucency is also changed by relative displacement of the two planar structures 3ac and 3bc relative to one another in the longitudinal direction. Both planar structures 3ac and 3bc are mounted on, in each case, one winding shaft 4ac, 4bc, to which torque is applied in the winding on direction by a winding spring. In the pulled-out functional position, the pull-out profile 5bc of the planar structure 3bc is hooked onto the upper suspension means 10 of the side door which are fixed to the door. The other pull-out profile 5ac, which is fixedly connected at the end side to the planar structure 3ac is bounded relative to the planar structure 3bc in the longitudinal direction by means of a compensation spring arrangement 8c, and is mounted so as to be movable in an elastically flexible fashion relative to the pull-out profile 5bc. As a result, the pull-out profile 5ac can be displaced in parallel relative to the other pull-out profile 5bc over a limited distance in the longitudinal direction of the shading structure. The control of a corresponding parallel displacement is carried out by means of the mechanical control device 11c, which acts on the winding shaft 4ac of the planar structure 3ac. The mechanical control device 11c has a toothing arrangement which meshes with an actuator wheel 6c which is rotatably mounted so as to be accessible from the vehicle passenger compartment in the region of the side door. The actuator wheel 6c serves as a manually operated actuator element of the mechanical control device 11c. The actuator wheel 6c is secured mechanically in different rotational positions. Corresponding rotation of the actuator wheel 6c accordingly inevitably brings about rotation of the winding shaft 4ac, as a result of which in the case of rotation in the winding on direction the planar structure 3ac is pulled down, and accordingly relative shifting of the strip sections, running transversely, of the two planar structures 3ac, 3bc relative to one another occurs. As a result, the desired change in the translucency of the shading structure 3 occurs in a way analogous to the illustrations according to FIGS. 2 and 3.

A similar embodiment of a shading system 2d is shown with reference to FIG. 12. In this shading system 2d, the two planar structures 3ad and 3bd are also provided, in a fashion not illustrated, with transversely running strip sections, as is illustrated in the embodiment according to FIGS. 1 to 3. The two planar structures 3ad and 3bd are secured in such a way that they can be wound onto, in each case, one winding shaft 4ad, 4bd and unwound therefrom, which planar structures 3ad and 3bd are positioned one on top of the other fixedly with respect to the door. The two planar structures 3ad, 3bd extend in an extended functional position according to FIG. 1 approximately in parallel to the side window arrangement in the upward direction and are secured in the region of upper suspension means 10 which are fixed to the door. For this purpose, the two pull-out profiles 5ad, 5bd are each provided with cutouts 15 and 14 through which corresponding suspension hooks of the suspension means 10 can pass. An essential difference from the embodiments described above is that each suspension means 10 is provided with an additional actuator hook 13 which can be adjusted to a limited degree in the vertical direction relative to the respective suspension hook. The vertical direction corresponds to the longitudinal direction of the planar structures 3ad, 3bd. In addition, the cutouts in the two pull-out profiles 5ad and 5bd are configured differently. The cutouts 15 of the pull-out profile 5ad are provided with a constant height over the entire width of the respective suspension hook. On the other hand, the cutouts 14 in the other pull-out profile 5bd have a considerably reduced height over the width of the respective suspension hook. A keyhole-like opening, into which the respective actuator pin 13 of the respective suspension means 10 projects, is provided in the upward direction merely in the region of the center of the respective cutout 14. The two actuator hooks 13 can be displaced in the vertical direction by means of a mechanical control device 11d in the form of a Bowden cable. The Bowden cable lid is controlled by a manually operated actuator wheel 6d, which is mounted fixedly with respect to the door and can be fixed mechanically in different positions. Rotation of the manually operated actuator wheel 6d by a vehicle occupant from the vehicle passenger compartment brings about longitudinal displacement of the Bowden cable 11d, as a result of which the two actuator pins 13 are forcibly raised and lowered synchronously. In this context, the pull-out profile 5ad, which is provided with the cutouts 15, is forcibly displaced upward or downward. Since the actuator pins 13 can be displaced vertically in the keyhole opening in the cutouts 14 in the other pull-out profile 5bd without this other pull-out profile Sad being moved along, a relative movement of the pull-out profile Sad forcibly occurs in the vertical direction and therefore in the longitudinal direction of the planar structures 3ad, 3bd relative to the pull-out profile 5bd which is secured to the suspension hook of the suspension means 10. This brings about the desired change in the translucency of the shading structure.

In the shading system 2e, whose function and use is provided in a way analogous to the embodiments described above, a shading structure is provided which is formed by two partial planar regions 3ae and 3be which are deflected by means of a deflection roller 16 and thereby form two partial planar regions which are parallel with respect to one another. The two partial planar regions of the shading region 3ae and 3be are provided in the same way with transversely running strip sections, as is the case in the shading system 2 according to FIGS. 1 to 3. The two partial planar regions 3ae and 3be of the shading structure are secured in such a way that they can be wound onto, in each case, one winding shaft 4ae, 4be and unwound therefrom, as is apparent from FIG. 14. The two winding shafts 4ae, 4be are mounted in parallel in such a way that they can move rotationally one on top of the other in the region of the inner side of the side door underneath the sill and fixedly with respect to the door. Torque is applied to both winding shafts 4ae, 4be in a manner not illustrated in more detail in the winding on direction with one winding spring in each case.

The deflection roller 16 is rotatably mounted in a dimensionally stable pull-out profile 5e which, in the pulled-out functional position of the shading structure, is secured in the upper suspension means 10 which are fixed to the door. An actuator wheel, which is connected to the deflection roller 16 in a coaxial and rotationally fixed fashion, is rotatably mounted in the pull-out profile 5e. The partial planar regions 3ae and 3be of the shading structure have cutouts relative to one another in the region of the actuator wheel 6e over the adjustment path of the partial planar regions 3ae, 3be. Rotation of the manually operated actuator wheel 6e forcibly gives rise to rotation of the deflection roller 16, which serves as a mechanical control device for the two partial planar regions 3ae and 3be by entraining the partial planar regions 3ae and 3be by means of corresponding deflection friction in the manner of cable friction. As a result, the two partial planar regions 3ae and 3be are adjusted to a limited degree relative to one another in the longitudinal direction, as a result of which the desired change in the translucency of the shading structure 3e is produced. A grip element on the pull-out profile 5e serves to move the pull-out profile 5e from a position of rest, in which the partial planar regions 3ae, 3be are wound onto the winding shafts 4ae, 4be, manually into the extended functional position.

In the embodiments according to FIGS. 15 and 16, translucency is not changed by relative displacement of planar structure parts relative to one another in the longitudinal direction but instead by relative displacement in the transverse direction. For this purpose, the two flexible planar structures 3af and 3bf are provided with strip sections, which are not denoted in more detail, running longitudinally, and which run in the longitudinal direction of the planar structures 3af, 3bf and are also configured in an alternating fashion one next to the other as dark and light strip sections. Both planar structures 3af, 3bf are secured in such a way that they can be wound onto, in each case, one winding shaft 4af, 4bf and unwound therefrom, which planar structures 3af, 3bf are arranged in parallel one on top of the other in the region of an inner side of the side door underneath a sill. The planar structure 3bf is fixedly connected at its front end region to the dimensionally stable pull-out profile 5bf which, in the pulled-out functional position, is secured fixedly to the door at the upper suspension means 10 which are fixed to the door. A further pull-out profile 5af is shiftably mounted within the pull-out profile 5bf in the transverse direction, which pull-out profile 5af is connected to the front end region of the other planar structure 3af. In addition, the winding shaft 4af, on which the planar structure 3af is secured, is shiftably mounted in the transverse direction and therefore in parallel with respect to a rotational axis of the winding shaft 4bf above a mounting 17 which is fixed to the door. In the pull-out profile 5bf, a mechanical sliding guide is provided for shifting the pull-out profile 5af, which sliding guide serves as a mechanical linear control for the pull-out profile 5af. A manually operated actuator slide 6f which is guided in a transversely shiftable fashion in a connecting link (not illustrated) of the pull-out profile 5bf, is fixedly connected to the pull-out profile 5af. Shifting of the actuator slide 6f in the transverse direction of the shading structure 3f (see directions of the arrows) accordingly brings about transverse displacement of the pull-out profile 5af, as a result of which the winding shaft 4af is displaced along in the transverse direction by means of the extended planar structure 3af. This results forcibly in relative displacement of the strip sections of the two planar structures 3af, 3bf relative to one another in the transverse direction, as a result of which the desired change in the translucency can be brought about.

In the embodiment according to FIG. 16, the shading system 2g also has a lower, transversely displaceable winding shaft 4ag. However, here the transverse adjustment takes place by means of a mechanical control device 11g in the form of a rack and pinion drive which acts on the lower winding shaft 4ag and is displaced in the transverse direction by means of a manually operated actuator wheel 6d. The actuator wheel 6d is rotatably mounted in the region of an inner side of the door. In addition, in synchronism with the transverse displacement of the lower winding shaft 4ag by means of a mechanical transmission means, here in the form of a Bowden cable, transverse displacement of the pull-out profile 5ag is also brought about, said pull-out profile 5ag being fixedly connected at the end side to the planar structure 3ag, which in turn is secured in such a way that it can be wound onto the winding shaft 4ag and unwound therefrom. For this purpose, a suspension hook 18 of the upper suspension means is movably mounted in the transverse direction. The Bowden cable engages on this suspension hook 18. The other pull-out profile 5bg, which is connected to the planar structure 3bg which is secured in such a way that it can be wound onto the upper winding shaft 4b and unwound therefrom has a cutout which is embodied as a longitudinal slot in the transverse direction, with the result that the pull-out profile 5bg remains in its secured position in the region of the upper suspension means while the first, abovementioned pull-out profile 5ag can be displaced transversely. The pull-out profile 5bg is additionally also provided with a transverse guidance means for the pull-out profile 5ag. The suspension hook 18 accordingly serves as a driver for the pull-out profile 5ag which can be displaced transversely. Transverse displacement of the pull-out profile 5ag and of the lower winding shaft 4ag takes place synchronously, with the result that no transverse stresses or twisting are applied to the planar structure 3ag itself.

The shading systems 2h and 2i according to FIGS. 17 and also permit the translucency of the respective shading structure to be changed by transverse displacement of the one planar structure 3ah, 3ai relative to the other planar structure 3bh, 3bi. In both shading systems 2h, 2i, in each case the winding shafts 4ah, 4ai on which the transversely displaceable planar structures 3ah, 3ai are secured in such a way that they can be wound on and unwound can be displaced in the transverse direction, i.e. coaxially with respect to their rotational axis. In addition, the pull-out profile 5ah, 5ai which is assigned at the end side to the respective planar structure 3ah, 3ai is also transversely displaceable. For this purpose, the respective pull-out profile 5ah, 5ai is shiftably mounted in a corresponding sliding guidance means within the other pull-out profile 5bh, 5bi. Both planar structures 3ah, 3bh; 3ai, 3bi are provided in each case with longitudinally running strip sections in a way analogous to the embodiments according to FIGS. 15 and 16. The respective pull-out profile 5bh, 5bi is fixedly suspended in the upper suspension means 10 which is fixed to the door. In the embodiment according to FIG. 17, a toothing section, which meshes with a pinion which is connected in a rotationally fixed fashion to an actuator lever 6h, is assigned directly to the transversely shiftable pull-out profile 5ah. The pinion in conjunction with the toothing section forms the mechanical control device 11h. Pivoting of the actuator lever 6h according to the direction of the arrow forcibly brings about displacement of the pull-out profile 5ah within the pull-out profile 5bh transversely with respect to the longitudinal direction of the planar structures 3ah, 3bh. The lower winding shaft 4ah is mounted in a floating fashion in the transverse direction, with the result that it is forcibly entrained by means of a corresponding tensile stress of the extended planar structure 3ah when transverse displacement of the pull-out profile 5ah occurs (see arrow).

The shading system 2i according to FIG. 18 is slightly modified. The transversely displaceable pull-out profile 5ae is also assigned here a toothing section which meshes with a pinion which is connected in a rotationally fixed fashion to an actuator wheel 6i. The actuator wheel 6i is rotatably mounted in the pull-out profile 5bi and is operated manually. The essential difference with respect to the embodiment according to FIG. 17 is that transverse displacement of the pull-out profile 5ai which is brought about by rotation of the actuator wheel 6i is transmitted to the winding shaft 4ai by means of a mechanical transmission device. The mechanical transmission device 3 has an actuator element 19 which is fixedly connected to the pull-out profile 5ai which is connected by means of a Bowden cable 20 to the winding shaft 4ai which is mounted in a floating fashion by means of a mounting (not illustrated). The winding springs which are depicted in the winding shafts 4ai, 4bi serve to exert a permanent tensile stress on the planar structures 3ai, 3bi in the extended functional position.

In the embodiment according to FIGS. 19 to 21, the shading system 2k has two planar structures 3ak, 3bk which are again provided with transversely running strip sections in a way analogous to the embodiment according to FIGS. 1 to 3. Both planar structures 3ak, 3bk are in each case rotatably mounted on a winding shaft 4ak, 4bk, which winding shafts 4ak, 4bk are positioned fixedly with respect to the door in parallel one on top of the other. Both planar structures 3ak, 3bk have at their upper end regions in each case a dimensionally stable pull-out profile 5ak, 5bk, which pull-out profiles 5ak, 5bk are secured in a carrier profile T by means of a mechanical control device 11k (FIG. 21). The carrier profile T is, as can be seen from FIGS. 19 and 20, embodied as a profiled clamp and provided with a central suspension eyelet (not denoted in more detail). By means of the corresponding suspension eyelet, the carrier profile T can be releasably secured to an upper suspension means which is fixed to the door. The mechanical control device 11k is formed by a crankshaft which is connected in an articulated fashion to the respective pull-out profile 5ak, 5bk at the center of gravity of the respective pull-out profile 5ak, 5bk. The crankshaft is coupled to a manually operated actuator lever 6k which is rotatable in two different functional positions through 90°, as can be seen from FIGS. 19 and 20. Rotation of the manually operated actuator lever 6k forcibly brings about rotation of the crankshaft of the mechanical control device 11k, as a result of which the pull-out profiles 5ak and 5bk are displaced in a limited fashion in parallel with respect to one another within the carrier profile T. This can be seen in FIGS. 19 to 21.

The shading system 21 according to FIGS. 22 to 25 is configured very similarly in its function to the shading system 2k. The essential difference in the shading system 21 is that the one pull-out profile 5al is fixed relative to the carrier profile T, while only the other pull-out profile 5bl is displaced relative to the carrier profile T by means of the crankshaft of the mechanical control device 111, by means of the pivotable actuator lever 61. This can be clearly seen in FIGS. 24 and 25. The carrier profile T extends over an entire width of the planar structures 3al, 3bl and has two suspension means which are spaced apart from one another, in order to be able to be secured fixedly to the door in the extended functional position. The actuator lever 61 is also movable in a pivoted fashion to a limited degree relative to the carrier profile T between two end positions of the crankshaft of the mechanical control device 111, which end positions are defined by an upper and a lower end position of the pull-out profile 5bl. The actuator lever 61 can, like the actuator lever 6k in the shading system 2k, be clamped in the respectively set position by corresponding pivoting, in order to secure the set relative displacement of the pull-out profiles 5ak, 5bk and 5l, 5bl relative to one another.

The shading system 2m also has a carrier profile T within which two pull-out profiles 5am, 5bm can be displaced so as to move relative to one another in the longitudinal direction of the planar structures 3am, 3bm. For this purpose, a mechanical control device 11m in the form of a rocker is provided, which can be operated manually by means of a rocker lever 6m. The rocker lever 6m is mounted in a rocking fashion on the carrier profile T and connected to the respective pull-out profile 5am, 5bm by means of one guide arrangement in each case. Both planar structures 3am, 3bm are provided with transversely running strip sections of different translucency and are secured in such a way that they can be wound onto, in each case, one winding shaft 4am, 4bm and unwound therefrom. The two winding shafts 4am, 4bm are mounted in parallel one on top of the other fixedly to the door.

In the embodiment according to FIGS. 28 to 37, a shading system 2n is provided which has two flexible planar structures 3an, 3bn which are movable transversely with respect to one another. The one planar structure 3an is displaceable in the vertical direction of the side door 1, as can be seen from FIGS. 28 to 30. The flexible planar structure 3an has, at its end region which is at the front in the pull-out direction, a dimensionally stable pull-out profile 5an which can be secured to upper suspension means which are fixed to the door (FIGS. 28 and 30). In addition, a further flexible planar structure 3bn is mounted on a side frame, on the right in FIGS. 28 and 29, of the side window arrangement S of the side door 1, which planar structure 3bn is displaceable in the transverse direction of the side window arrangement, i.e. essentially in the longitudinal direction of the vehicle, while the other planar structure 3an is displaced along the side window arrangement S essentially in the vertical direction of the vehicle. The planar structure 3an is provided with longitudinally running strip sections, which are not denoted in more detail and which in the extended functional position are extended essentially in the vertical direction of the vehicle. The planar structure 3bn is provided with strip sections which run transversely relative to the pull-out direction, i.e. to the longitudinal direction of the planar structure 3bn, and which are matched in their width to the strip sections of the planar structure 3an. The planar structure 3bn is secured (in a way which is not illustrated in more detail) in such a way that it can be wound onto a winding shaft and unwound therefrom, which winding shaft is oriented essentially in the vertical direction of the vehicle within the side frame of the side window arrangement of the side door 1, and rotatably mounted. The winding shaft can be configured in a conical fashion in order to be able to compensate slightly oblique winding on and unwinding of the planar structure 3bn. It is apparent from FIG. 31 that in the transversely pulled-out functional position the planar structure 3bn complements the longitudinally pulled-out planar structure San in such a way that in each case opaque strip sections are adjacent to translucent strip sections and are partially or completely superimposed on, resulting in translucency which is reduced to a maximum in the functional position according to FIG. 31. A dimensionally stable pull-out profile 5bn is assigned to the planar structure 3bn at its end region which is at the front in the pull-out direction, said pull-out profile 5bn being mounted in such a way that it can be adjusted to a limited degree relative to a side edge, on the left in the illustration according to FIGS. 30 to 32, of the side window arrangement of the side door 1, by means of a mechanical control device 11n. In this context, the pull-out profile 5bn can be displaced in parallel with respect to the orientation of the strip sections, over a limited movement path away from the side edge or toward the side edge. The mechanical control device 11n has a rack and pinion drive which is activated by means of a manually operated actuation knurl 6n, as is clearly apparent in FIGS. 33b to 33f. The rack and pinion drive has a rack and pinion section which can be connected to the pull-out profile 5bn by means of a suspension hook. The rack and pinion section which is provided with the suspension hook is mounted in a shiftable fashion on the door side. Shifting and resulting adjustment of the rack and pinion section is carried out by means of a toothed pinion which is rotatably mounted on the door side and is connected coaxially and in a rotationally fixed fashion to the knurl-like actuator wheel 6n. The actuator wheel 6n projects through a slot in the internal trim of a door toward the vehicle passenger compartment, with the result that the actuator wheel 6n can be operated from the vehicle passenger compartment. The change in the translucency of the shading system 2n can be achieved by simply rotating the actuator wheel 6n.

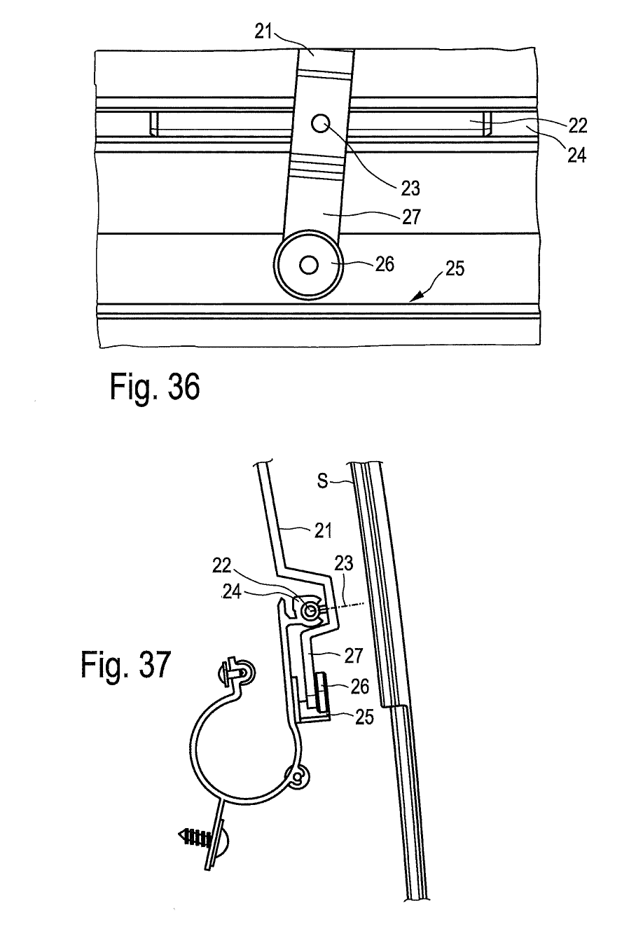

FIGS. 34 to 37 show how the pull-out profile 5bn is displaced along the side window arrangement S, essentially in the longitudinal direction of the vehicle. The pull-out profile 5bn is assigned a control lever 21 which is secured to a guide carriage 22 by means of a rotary joint 23. The control lever 21 engages approximately in a central region at a pivot point on the pull-out profile 5bn, as can be clearly seen in FIG. 35. The control lever 21 projects upward, essentially in the vertical direction of the vehicle, while the guide carriage 22 is mounted so as to be displaceable essentially in the longitudinal direction of the vehicle in a guide rail arrangement 24, 25 which is fixed to the door. The control lever 21 also has a supporting extension 27 which projects downward beyond the rotary joint 23, and a supporting roller is rotatably mounted at the lower end region of said supporting extension 27. The supporting roller 26 has a rotational axis which is parallel with respect to the rotary joint 23 and extends essentially in the transverse direction of the vehicle. The supporting roller 26 is supported on a guide profile 25 of the guide rail arrangement 24, 25. In this context, the support is selected in such a way that the control lever 21 is continuously inclined slightly obliquely forward in the pull-out direction of the planar structure 3bn. Since a continuous restoring force acts on the winding shaft of the planar structure 3bn as a result of a winding spring which is integrated in the winding shaft, the support of the control lever 21 in the slightly oblique position (see, in particular, FIGS. 35 and 36), brings about a continuous counter-support counter to the restoring force of the winding spring, which also forcibly acts on the pull-out profile 5bn. As a result, the pull-out profile 5bn is always secured in a stable fashion in an upright position even without suspension means in the region of the extended functional position, with the result that parallel displacement of the pull-out profile 5bn between the retracted position of the rest of the planar structure 3bn and the extended functional position at least largely takes place. The illustrations according to FIGS. 34 to 36 are each viewed from the outside, i.e. from the side of the side window arrangement S.

1. Shading system for a vehicle passenger compartment having at least one flexible planar structure which is mounted in such a way that it can be wound onto at least one winding shaft between a wound-on position of rest and at least one at least partially extended functional position and unwound therefrom, and which has a plurality of strip sections which are extended in parallel with respect to one another and which have different translucency values, as well as having a control device which changes the translucency of the planar structure through spatial displacement of the planar structure, wherein two flexible planar structures which can be displaced in parallel or transversely with respect to one another are provided, which planar structures are each provided with strip sections which run longitudinally or transversely and have different translucency values, and in that the control device acts mechanically on at least one planar structure and has at least one actuator element which can be operated manually.

2. Shading system according to claim 1, wherein planar structure is mounted in such a way that it can be wound onto, in each case, a winding shaft and unwound therefrom, wherein the winding shafts are oriented in parallel or at an angle with respect to one another.

3. Shading system for a vehicle passenger compartment having at least one flexible planar structure which is mounted in such a way that it can be wound onto at least one winding shaft between a wound-on position of rest and at least one at least partially extended functional position and unwound therefrom, and which has a plurality of strip sections which are extended in parallel with respect to one another and which have different translucency values, as well as having a control device which changes the translucency of the planar structure through spatial displacement of the planar structure, wherein an individual flexible planar structure is provided which is deflected to form two partial planar regions which are positioned one on top of the other and are at least largely parallel with respect to one another.

4. Shading system according to claim 3, wherein the two partial planar regions are secured on a common winding shaft that they can be wound thereon and unwound therefrom.

5. Shading system according to claim 3, wherein in each case one winding shaft is provided for each of the two partial planar regions, in order to wind on or unwind the respective partial planar region.

6. Shading system according to claim 3, wherein a dimensionally stable pull-out profile is assigned to each partial planar region at an end region which is at the front in the unwinding direction.

7. Shading system according to claim 3, wherein at least one partial planar region is deflected by means of a clamping strip which exerts a tensile load on the partial planar region in the longitudinal direction of the planar structure.

8. Shading system according to claim 1, wherein each planar structure has a dimensionally stable pull-out profile at its end region which is at the front in the unwinding direction.

9. Shading system according to claim 8, wherein at least one pull-out profile and/or at least one winding shaft is/are mounted so as to be movable in the longitudinal direction or transverse direction of the planar structure, and the control device has at least one mechanical control means which, when activation by the manually operated actuator element occurs, exerts forced guidance on at least one pull-out profile and/or at least one winding shaft in the longitudinal direction or transverse direction.

10. Shading system according to claim 9, wherein the mechanical control means has a mechanical operative connection to the manually operated actuator element.

11. Shading system according to claim 1, wherein, when there are two flexible planar structures which can be displaced transversely with respect to one another, one planar structure can be displaced essentially in the longitudinal direction of the vehicle, and in that a pull-out profile of the planar structure can be displaced by means of an individual lateral guidance means, which can be mounted fixedly with respect to the vehicle, and a control lever which is mounted on a guide carriage of the lateral guidance means.

12. Shading system according to claim 11, wherein the control lever has a supporting extension which projects over the guide carriage in the opposite direction to the pull-out profile and is supported in the lateral guidance means by means of a supporting roller.

13. Shading system according to claim 1, wherein the two pull-out profiles of the planar structures are adjustably secured in a common carrier profile, the shading system further including mechanical control means assigned to the carrier profile.

14. Shading system according to claim 13, wherein the manually operated actuator element is mounted on the carrier profile.

15. Shading system according to claim 1, wherein the manually operated actuator element is mounted on the vehicle passenger compartment side.

16. Shading system according to claim 3, wherein each partial planar region has a dimensionally stable pull-out profile at its end region which is at the front in the unwinding direction.

17. Shading system according to claim 16, wherein at least one pull-out profile and/or at least one winding shaft is/are mounted so as to be movable in the longitudinal direction or transverse direction of the partial planar region, and the control device has at least one mechanical control means which, when activation by a manually operated actuator element occurs, exerts forced guidance on at least one pull-out profile and/or at least one winding shaft in the longitudinal direction or transverse direction.

18. Shading system according to claim 17, wherein the mechanical control means has a mechanical operative connection to the manually operated actuator element.

19. Shading system according to claim 3, wherein the two pull-out profiles of the partial planar regions are adjustably secured in a common carrier profile, the shading system further including mechanical control means assigned to the carrier profile.

20. Shading system according to claim 19, wherein a manually operated actuator element is mounted on the carrier profile.
